(19) United States
(12) Patent Application Publication
(10) Pub. No.: US 2012/0144963 A1
(43) Pub. Date: Jun. 14, 2012

(54) LABORSAVING PLIERS

(76) Inventor: Chia-Sung HE, Taipei (TW)

(21) Appl. No.: 13/313,590

(22) Filed: Dec. 7, 2011

(30) Foreign Application Priority Data
Dec. 13, 2010 (TW) 099224119

(51) Int. Cl. B25B 7/12

(52) U.S. Cl. 81/381

(57) ABSTRACT

Laborsaving pliers includes a first main body composed of a first handle at a lower end and a first working portion at the upper side. The first working portion is provided with a first combining member having a first jaw, and an arcuate slide groove is bored between the first combining member and the first handle. A second working portion is provided with a second combining member to be combined with the first combining member, having a second jaw corresponding with the first jaw, and the second combining portion has fixed with a combining rod. A second handle has an upper end secured with a sliding rod to slide in the arcuate slide groove, having a slide-joint groove positioned adjacent to the center for the combining rod to slide therein.

### BACKGROUND OF THE INVENTION

1. Field of the Invention

This invention relates to pliers, particularly to laborsaving pliers.

2. Description of the Prior Art

Conventional pliers contain two opposite pliers portions respectively formed with a working end and a grasping end. After the two pliers portions are intersected with each other and pivotally combined together to make up a pair of pliers. Then the two grasping ends of the pliers can be opened or closed to carry out movement of opening and closing of the two working ends. Therefore, the working ends of the pliers can be operated in different modes for attaining different functions, such as cutting, compression and the like in accordance with practical needs. Based on the principle of a lever, the working ends of the pliers are regarded as resistive force arms while the grasping ends regarded as motive force arms. If the working ends need greater force, the grasping ends must be longer accordingly. Apart from lengthening the grasping ends of the pliers for increasing the force of the working ends, a floating fulcrum is provided on a working handle, and through the floating fulcrum, the force arms of the handle can be lengthened and the force applied to the working ends can be increased.

Although the conventional laborsaving pliers are able to increase the length of the force arms, yet the moving positions of the floating fulcrum are limited; therefore, the effect of lengthening the force arms falls short of expectations, and the opening width of the pliers fails to be enlarged.

### SUMMARY OF THE INVENTION

The objective of this invention is to offer laborsaving pliers mainly containing a first main body 10, a second working portion 20 and a second handle 30. The first main body 10 is composed of a first handle 11 at a lower end and a first working portion 12 positioned opposite to the topside of the first handle 11. The first working portion 12 is provided thereon with a first combining member 121 having one side of its upper end formed with a first jaw 123, and an arcuate slide groove 13 is bored between the first combining member 121 and the first handle 11. The second working portion 20 relative to the first working portion 12 is disposed with a second combining member 21 to be combined with the first combining member 121 to enable the first working portion 12 and the second working portion 20 to produce movement of relative rotation. Further, the second working portion 20 has one side of its upper end formed with a second jaw 22 opposite to the first jaw 123, and the second combining member 21 of the second working portion 20 has a lower side fixed with a combining rod 23. The second handle 30 has an upper end secured with a sliding rod 31 to slidably move in the arcuate slide groove 13 and has a slide-joint groove 32 bored at a location adjacent to the center for the combining rod 23 to slide therein.

The laborsaving pliers in the present invention is provided with floating fulcrums to have the sliding rod 31 sliding in the arcuate slide groove 13 and have the combining rod 23 sliding in the slide-joint groove 32, able to increase the length of the force arms and relatively increase the force between the first jaw 123 and the second jaw 22.

### BRIEF DESCRIPTION OF DRAWINGS

This invention will be better understood by referring to the accompanying drawings, wherein:

FIG. 1 is a perspective view of a first preferred embodiment of laborsaving pliers in the present invention;

FIG. 2 is an exploded perspective view of the first preferred embodiment of the laborsaving pliers in the present invention;

FIG. 3 is a schematic view of the first preferred embodiment of the laborsaving pliers operated to make two jaws stretched open in the present invention;

FIG. 4 is a schematic view of the first preferred embodiment of the laborsaving pliers applied with force in the present invention;

FIG. 5 is a schematic view of the first preferred embodiment of the laborsaving pliers operated to make two jaws closed in the present invention; and

FIG. 6 is a schematic view of a second preferred embodiment of the laborsaving pliers in the present invention.

### DETAILED DESCRIPTION OF THE PREFERRED EMBODIMENT

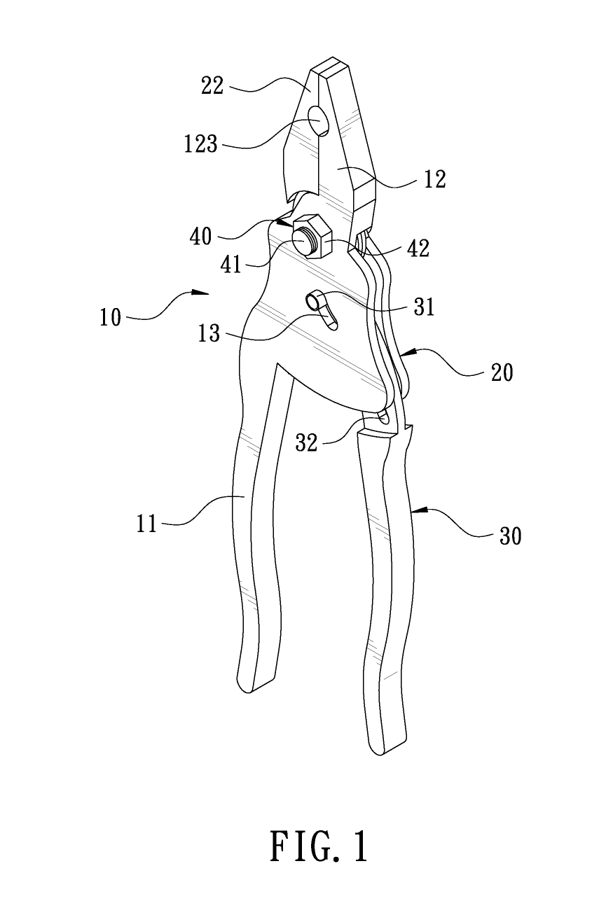

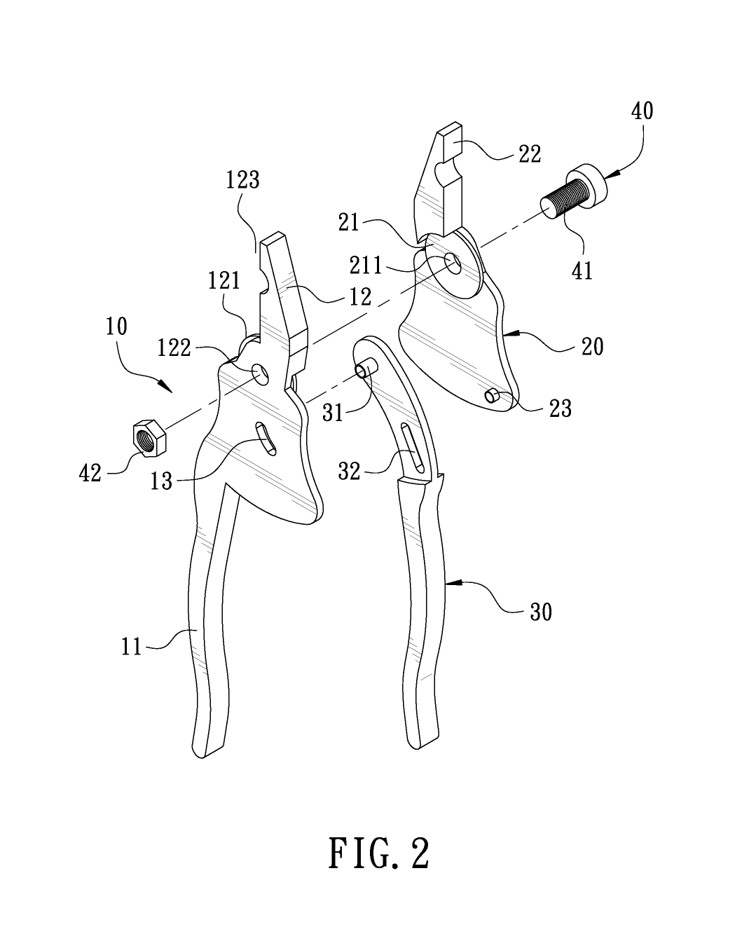

A first preferred embodiment of laborsaving pliers in the present invention, as shown in FIGS. 1 and 2, includes a first main body 10, a second working portion 20, a second handle 30 and a fixing member 50 as main components combined together.

The first main body 10 has its lower end formed with a first handle 11 having its upper end formed with a first working portion 12 provided thereon with a first combining member 121 with a disc surface bored with a through hole 122 in the center. The first working portion 12 has one side of its upper end disposed with a first jaw 123, and an arcuate slide groove 13 is bored at a location between the first combining member 121 and the first handle 11.

The second working portion 20 relative to the first working portion 12 is provided with a second combining member 21 to be coincided with the first combining member 121. The second combination 21 is also a disc surface opposite to the first combining member 121 and is bored with a through hole 211 in the center to enable the first working portion 12 and the second working portion 20 to produce movement of relative rotation. The second working portion 20 has one side of its upper end formed with a second jaw 22 to correspond with the first jaw 123. The first jaw 123 and the second jaw 22 can be driven to move close to each other or keep away from each other at a great distance via mutual rotation of the first working portion 12 and the second working portion 20. Further, the second combining member 21 of the second working portion 20 is fixed with a combining rod 23 protruding out at a lower side.

The second handle 30 is a shank having its upper end provided with a protruding sliding rod 31 slidably moving in the arcuate slide groove 13 and is disposed with a slide-joint groove 32 at a location adjacent to the center for the combining rod 23 of the second combination portion 21 to slide therein.

The fixing member 40 is composed of a bolt 41 and a nut 42 and can be a rivet. After the bolt 41 is inserted through the through hole 122 of the first combining member 121 and the through hole 211 of the second combining member 21, the end of the bolt 41 is locked with the nut 42.

In order to further understand the structure, the features, technological measures and expected efficacy of the invention, how to use it is to be described below. Then the invention will be more clearly understood.

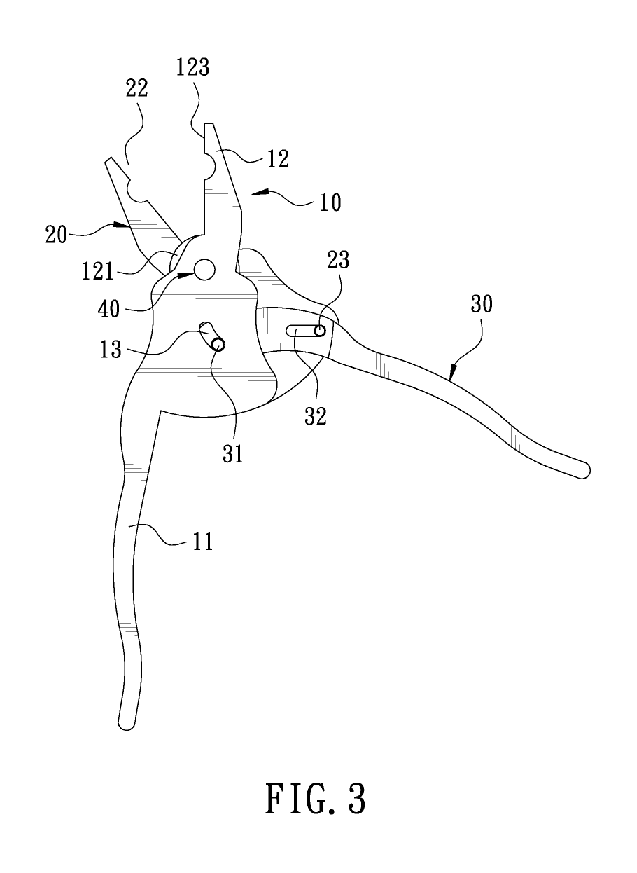

In using, to stretch the first jaw 123 and the second jaw 22 open fully, referring to FIG. 3, the first handle 11 and the second handle 30 are respectively and oppositely moved outward and at this time, the sliding rod 31 is positioned at the lower side of the arcuate slide groove 13, and the combining rod 23 also comes to the lower side of the slide-joint groove 32, thus forming a maximum interval between the first jaw 123 and the second jaw 22. Such a design is able to enlarge the opening of the first jaw 123 and the second jaw 22 for receiving a work piece with a greater breadth.

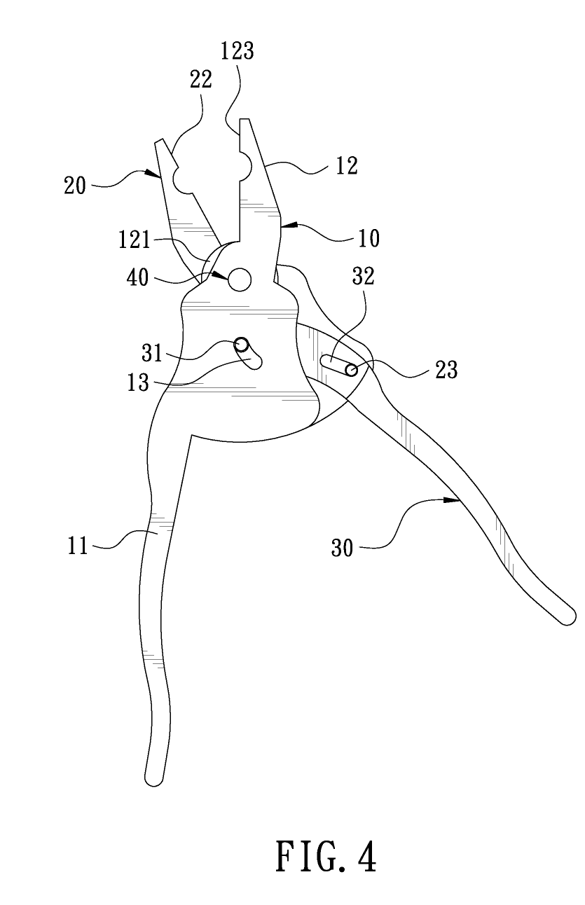

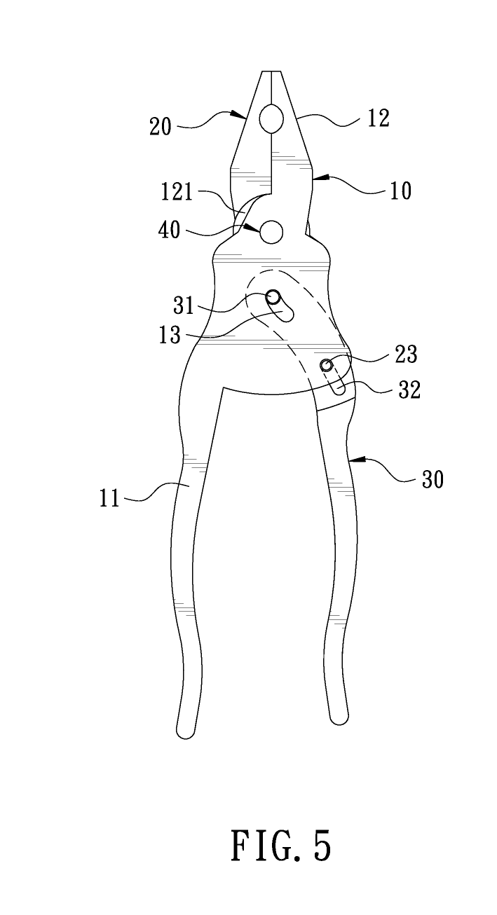

In operating this pliers, referring to FIGS. 4 and 5, when the first handle 11 and the second handle 30 are oppositely moved inward by application of force with the fixing member 40 acting as a fulcrum, the sliding rod 31 of the second handle 30 will slidably move to the upper end of arcuate slide groove 13, and there will produce a force arm between the sliding rod 31 and the fixing member 40. And the sliding rod 31 functions also as a fulcrum and there will also produce another force arm between the sliding rod 31 and the combining rod 23, and when the second handle portion 30 is continuously moved inward, the combining rod 23 will be actuated to slide toward the upper end of the slide-joint groove 32. Thus, through synergistic effects of the two force arms mentioned above, the force applied to both the first handle 11 and the second handle 30 can be greatly added, and thus the force applied to a work piece by both the first jaw 123 and the second jaw 22 will be increased not a little.

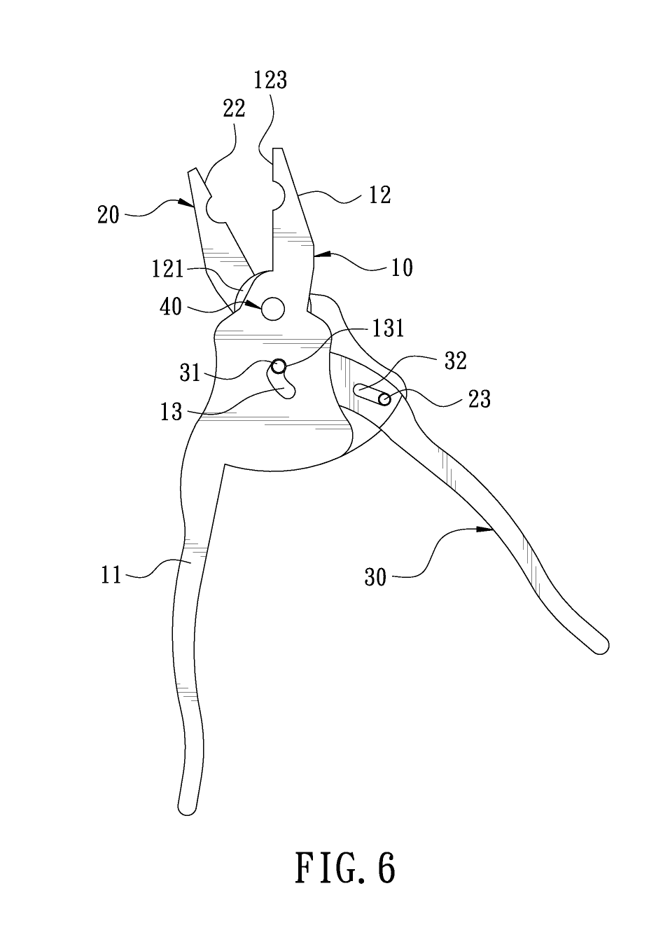

A second preferred embodiment of laborsaving pliers in the present invention, as shown in FIG. 6, has almost the same structure as that of the first preferred embodiment, except that a position-limiting groove 131 is additionally provided at the upper end of the arcuate slide groove 13 for restrictedly positioning the sliding rod 31. When force applied to both the first handle 11 and the second handle 30 are not great or the working breadth between the first jaw 123 and the second jaw 22 is needless to be stretched open too large, the sliding rod 31 can be restrictedly positioned in the position-limiting groove 131 and it only needs a force arm produced between the combination rod 23 and the fixing member 40.

While the preferred embodiments of the invention have been described above, it will be recognized and understood that various modifications may be made therein and the appended claims are intended to cover all such modifications that may fall within the spirit and scope of the invention.

What is claimed is:

1. Laborsaving pliers comprising:
a first main body 10 having a lower end formed with a first handle 11, said first handle 11 having an upper side provided with a first working portion 12, said first working portion 12 set thereon with a first combining member 121, said first combining member 121 having one side of an upper end formed with a first jaw 123;
a second working portion 20 relative to said first working portion 12, said second working portion 20 disposed with a second combining member 21 to be combined with said first combining member 121, said first working portion 12 and said second working portion 20 able to produce movement of relative rotation, said second working portion 20 having an upper end provided with a second jaw 22 corresponding with said first jaw 123, an arcuate slide groove 13 formed between said first combining member 121 and said first handle 11, a protruding combining rod 23 fixed at a lower side of said second combining member 21 of said working portion 20; and
a second handle 30 having an upper end disposed with a sliding rod 31 to slide in said arcuate slide groove 13, a slide-joint groove 32 formed at a location adjacent to a center of said second handle 30, said combination rod 23 slidably positioned in said slide-joint groove 32.

2. The laborsaving pliers as claimed in claim 1, wherein said arcuate slide groove 13 has at least one end provided with a position-limiting groove 131.

3. The laborsaving pliers as claimed in claim 1, wherein said combining member 121 is a disc surface, said disc surface bored with a through hole 122 in the center, said second combining member 21 also being a disc surface corresponding with said first combining member 121, said second combining member 21 bored with a through hole 211 in a center, said first combining member 121 and said second combination member 21 pivotally combined together by a fixing member 40 after said through holes 122 and 211 of said first combining member 121 and said second combining member 21 are coincided with each other.

4. The laborsaving pliers as claimed in claim 3, wherein said fixing member 40 is composed of a bolt 41 and a nut 42, said bolt 41 having an end locked with said nut 42 after said bolt 41 is inserted through both said through hole 122 of said first combining member 121 and said through hole 211 of said second combining member 21.

5. The laborsaving pliers as claimed in claim 3, wherein said fixing member 40 is a rivet.
